(19) United States
(12) Patent Application Publication
(10) Pub. No.: US 2009/0193444 A1
(43) Pub. Date: Jul. 30, 2009

(54) TECHNIQUES FOR CREATING AND MANAGING EXTENSIONS

(75) Inventors: Jason Clark, Bothell, WA (US); Liangxiao Zhu, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/021,300

(22) Filed: Jan. 29, 2008

(51) Int. Cl. G06F 9/44

(52) U.S. Cl. 719/331

(57) ABSTRACT

Various technologies and techniques are disclosed for creating and managing extensions. An extension manager is operable to interact with and manage extensions in at least two categories, such as operative extensions and cooperative extensions. The extension manager loads zero or more extensions from a first set of extensions into a host application. The extension manager loads zero or more extensions from a second set of extensions into the host application based upon an analysis of one or more declarations of compatibility. An extension manager framework is described that has a language syntax for describing the operation of extensions. The language syntax enables a cooperative extension to declare compatibility with operative extensions, so that the cooperative extension is only loaded into a host application in situations where the cooperative extension has been pre-defined as being compatible. A process for loading extensions in a host application using declarations of compatibility is described.

### BACKGROUND

Many software applications can be extended with custom functionality. Custom functionality is often provided through an extension. An “extension”, often called an add-in or plugin, is a component that is loaded into a host application. A “host application” is an application being extended by an extension. As one or more extensions are loaded into a host application, the host application then encompasses any code that is active within the host application at that time. Extensions are typically discovered dynamically and then loaded by the host application. An extension is designed to expand the functionality of the host application beyond what the host application provides standing alone. For example, an extension might be used from within a word processing program to search the Internet for articles relating to a certain word that was typed within the word processing program. In this example, the host application is the word processing program, and the Internet search tool is the extension.

Extensions are typically created as a dynamic link library (DLL), shared object, archives bundle or other program that the host application can load. Some extensions do not work well with other extensions, or only work with certain other extensions. In current scenarios, the host application typically loads all activated extensions and then later handles the errors or incompatibilities that may occur due to these conflicts when the host application knows how to handle the conflicts. When the host application does not know how to handle the conflicts, the host application can crash or otherwise suffer in some fashion.

### SUMMARY

Various technologies and techniques are disclosed for creating and managing extensions. An extension manager is operable to interact with and manage extensions in at least two categories. A first set of extensions belongs to a first category of extensions, such as operative extensions. A second set of the extensions belongs to a second category of extensions, such as cooperative extensions. The second set of extensions contains one or more declarations of compatibility with one or more extensions in the first set of extensions. The extension manager is operable to load zero or more of the first set of extensions into a host application. The extension manager is also operable to load zero or more of the second set of extensions into the host application based upon an analysis of the one or more declarations of compatibility. In other words, the declarations of compatibility determine which extensions in the second set of extensions actually get loaded.

In one implementation, an extension manager framework is described. The framework has a language syntax for describing the operation of a plurality of extensions. The language syntax is operable to enable a cooperative extension to declare compatibility with one or more operative extensions, so that the cooperative extension is only loaded into a host application in situations where the cooperative extension has been pre-defined as being compatible.

In another implementation, a process for loading extensions using declarations of compatibility is described. An extension loading process is initiated for a host application. Zero or more operative extensions are loaded into the host application. At least one declaration of compatibility assigned to at least one cooperative extension is analyzed. When the analyzing step reveals that at least one cooperative extension is compatible with the zero or more operative extensions that are being loaded, then the at least one cooperative extension is loaded into the host application.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of an extension manager system of one implementation.

FIG. 2 is a diagrammatic view of an extension manager framework of one implementation.

FIG. 3 is a process flow diagram for one implementation illustrating the stages involved in loading extensions into a host application based upon extension declarations.

FIG. 4 is a process flow diagram for one implementation illustrating the stages involved in loading proxy behaviors.

FIG. 5 is a process flow diagram for one implementation illustrating the stages involved in using proxy behaviors at runtime.

FIG. 6 is a process flow diagram for one implementation illustrating the stages involved in binding an extension to different levels in an implementation hierarchy based upon declarations of compatibility.

FIG. 7 is a diagrammatic view of an exemplary derivation hierarchy to which declarations of compatibility could be bound.

FIG. 8 is a diagrammatic view of a computer system of one implementation.

### DETAILED DESCRIPTION

The technologies and techniques herein may be described in the general context as techniques for creating and managing extensions, but the technologies and techniques also serve other purposes in addition to these. In one implementation, one or more of the techniques described herein can be implemented as features within a software development program such as MICROSOFT® VISUAL STUDIO®, a framework environment such as MICROSOFT®.NET Framework, or from any other type of program or service that allows for creation and/or management of extensions.

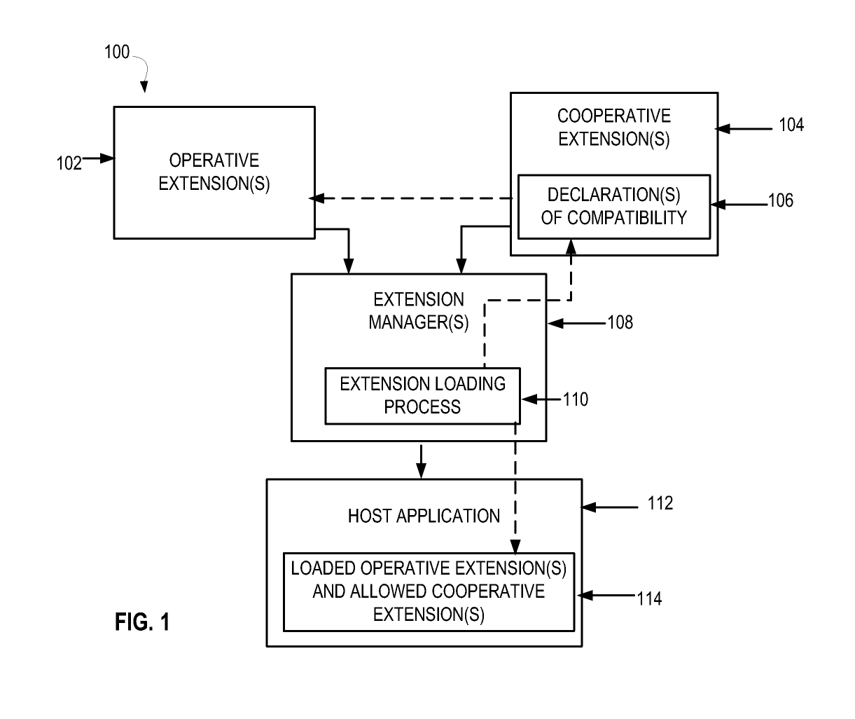

As described in further detail herein, an extension manager system provides technologies and techniques that enable extensions (such as extensions in one category of extensions) to declare their compatibility and/or incompatibility with other extensions (such as extensions in another category of extensions). For example, cooperative extensions can declare their compatibility with operative extensions, as described in further detail in FIGS. 1-6. An extension manager can then use the declarations of compatibility to determine which extensions are allowed to be loaded at the same time with other extensions.

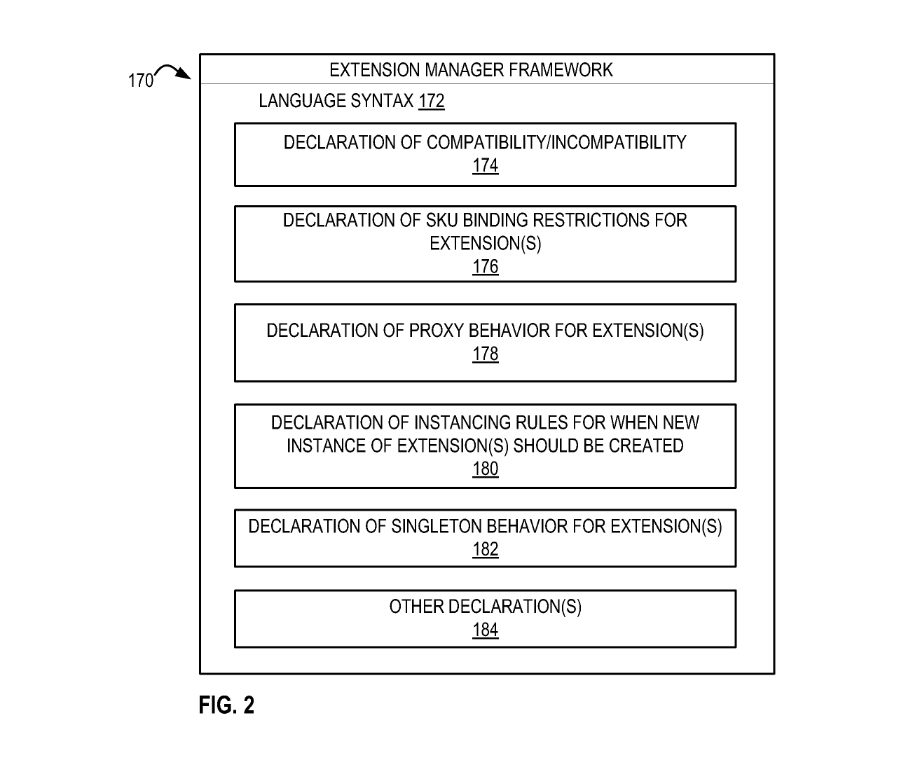

In one implementation, a framework is provided that has a language syntax that allows a developer or other end user to specify various details about the extension, including the declarations of compatibility. For example, the language syntax allows proxy behaviors to be specified for extensions, such as to indicate what should happen when errors occur. This framework facilitates the development of extensions in ways that can have provider agnostic portions and provider specific portions of the application. This framework is described in further detail in FIG. 2. In one implementation, some or all of these techniques described herein can help reduce the degree of complications that can result from runtime discovery of other extensions (that may or may not be compatible with one another). In another implementation, some or all of the techniques described herein can enable a software developer the ability to choose between interacting with complex and flexible extension implementations or more limited and typesafe, but simple extension implementations. In other words, the ability to specify what extensions should interact together can enable developers to choose to allow a given extension to interact with other extensions that facilitate overall flexibility or safety, depending on which is more appropriate for the situation.

As shown in FIG. 1, an extension manager system 100 has various components. These components can include zero or more operative extensions 102 (e.g. first category of extensions), zero or more cooperative extensions 104 (e.g. second category of extensions), one or more extension managers 108, and a host application 112. The term “operative extension” as used herein is meant to include an extension that serves to help establish a collective identity used in the loading of other extensions. In a sense, operative extensions can help declare a sort of application “DNA” (as an analogy to human “DNA”) that defines a collective identity of a particular host application. The term “cooperative extension” as used herein is meant to include an extension which is loaded or not loaded depending on a declared compatibility and/or incompatibility with a set of operative extensions. The same extension could be considered an operative extension in one scenario, yet a cooperative extension in another scenario. For example, there could be some configurations of a host application where a particular extension would be an operative extension, yet other configurations of the same or different host application where that particular extension is treated as a cooperative extension. The cooperative extensions can each contain zero or more declarations of compatibility 106. A “declaration of compatibility” is information that describes one or more other extensions that the specified extension is compatible or incompatible with.

A declaration of compatibility can declare a specific compatibility or incompatibility with an operative extension or a grouping of operative extensions in one of various ways. As one non-limiting example, object oriented type inheritance can be used to indicate that a given cooperative extension should be loaded (or not loaded) when an operative extension that derives from a particular base class is loaded. As another non-limiting example, a strict type matching technique could be used in an object oriented fashion so that a given cooperative extension is only loaded if a very specific operative extension is loaded. Yet another non-limiting example for specifying declarations of compatibility includes a tag-matching scheme where the cooperative extension is tagged with a unique name or other identifier of the operative extension to which compatibility or incompatibility is being declared. Any other technique that would allow a given cooperative extension to indicate its compatibility and/or incompatibility with operative extension(s) can also be used.

A declaration of compatibility can be contained in various locations, such as compiled as part of an executable version of the extension (such as in the DLL or EXE file) or contained in an extension file. Declarations of compatibility could also be stored in other locations, such a database, or in any other format for storing information as would occur to one in the computer software art. More details regarding a declaration of compatibility and a corresponding code example are provided in the discussion of FIG. 2.

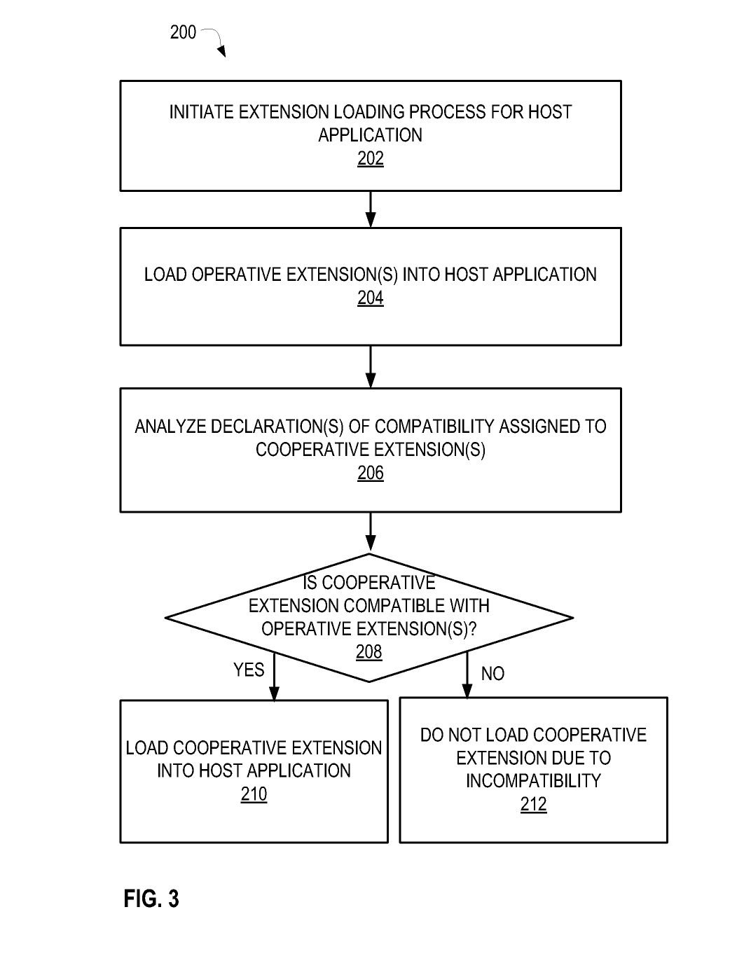

Extension manager 108 is responsible for initiating an extension loading process 110 to load the operative extension(s) 102 and the appropriate cooperative extension(s) 104 into the host application 112. The extension manager 108 accesses the declaration(s) of compatibility 106 to determine which cooperative extension(s) 104 can be loaded with the operative extension(s) 102 that are also being loaded. In one implementation, the declarations of compatibility are accessed at the time extensions are being loaded into a host application in order to determine which cooperative extensions to load. In another implementation, extension compatibilities can be statically established at install time, and then retrieved during an extension loading process to determine which cooperative extensions to load. The load process is described in further detail in FIGS. 3-6. Once the extension manager 108 is finished loading the operative extension(s) 102 and cooperative extension(s) 104, the host application 112 then contains those extensions in memory 114. In one implementation, extension manager 108 still continues to interact with host application 112 to assist with operation of the extensions, such as to handle errors and/or other extension management issues. A few non-limiting examples of extension management issues can include the creation of extensions, determination of a current set of loaded instances, discovery of errors in loaded extensions, and so on.

In one implementation, each instance of extension manager 108 maintains an extension context that reflects certain extension loading criteria. A host application may choose to instantiate any number of extension manager instances to support its extension loading context needs. For example, perhaps an application that manages a project system might use a single instance of the extension manager 108 for each currently loaded project or project type, depending on the granularity of context needed. Meanwhile, a simpler application may just use a single instance of the extension manager 108 for the life of the application.

In one implementation, cooperative extension(s) 104 can request information from the extension manager 108 about currently loaded extensions. The host application can receive a list of implementing extensions from the extension manager 108, and this list can reflect various filtering including, extension compatibility, base type inheritance, SKU restrictions, default instance specification, etc. Some of this information that can be provided to the cooperative extension(s) 104 and otherwise used for other operations of extension manager system 100 will be described in further detail in FIG. 2.

FIG. 2 is a diagrammatic view of an extension manager framework of one implementation. As shown in FIG. 2, extension manager framework 170 contains a language syntax that enables various details to be declared and/or described for a given extension and/or category of extension. These declarations can be used with operative extensions and/or cooperative extensions. For example, in some implementations, one or more declarations may only be supported for cooperative extensions. In other implementations, one or more declarations may be supported by both cooperative extensions and operative extensions. In other implementations, one or more declarations may only be supported for operative extensions. Language syntax 172 includes a declaration of compatibility/incompatibility 174. An example will now be illustrated to further illustrate the concept of a declaration of compatibility/incompatibility 174.

A single cooperative extension may declare its compatibility with multiple operative extensions. Here is an example of what an extension compatibility declaration can look like in code:

// declares compatibility with inheriting extensions
[ProviderCompatibility(typeof(SqlDatabaseSchemaProvider))]
public sealed class MyExtension : SomeExtensibiltyPoint
{
}
// declares compatibility w/all implementations of example extension
[ProviderCompatibility(typeof(DatabaseSchemaProvider))]
public sealed class MyExtension : SomeExtensibiltyPoint
{
}
// declares compatibility with specific implementations
// avoids matching unknown implements in the future
// without first recompiling extension
[ProviderCompatibility(typeof(Sql90SchemaProvider))]
[ProviderCompatibility(typeof(Sql80SchemaProvider))]
public sealed class MyExtension : SomeExtensibiltyPoint
{
}

In one implementation, this approach to extensibility (by declaring compatibility) enables the development of generic extensions and specific extensions, all living together in the same extension ecosystem. Extensions do not need to use dynamic discovery or later analysis to determine if they are compatible with the current host application. In such a scenario, extensions can be assured that if they are activated at all, then they are working in an application with compatible specifics.

Continuing on with the next declaration on FIG. 2, language syntax 172 also supports a declaration of SKU binding restrictions 176 for one or more extensions. SKU binding restrictions allow extensions to declare one or more restrictions for whether or not to load based upon current SKU configuration. In other words, there may be times when an end user does not have a license for a certain product, so one or more extensions should not be allowed to load. In one implementation, SKU binding restrictions can be applied to enable only extensions of a certain type to be loaded if the binding classification for the SKU is satisfied. Alternatively or additionally, SKU binding restrictions can be applied to a particular extension, which will cause the extension not to load if the declared SKU condition is not satisfied. A non-limiting example of how binding restrictions can be specified is shown below:

```
// This feature can be load in TeamSystem SKU, and will not be loaded
  // for those SKUs below TeamSystem.
  [BindingClassification(BindingClassification.TeamSystem)]
  public interface IGenerator : IConfigurableExtension
  {
  }
```

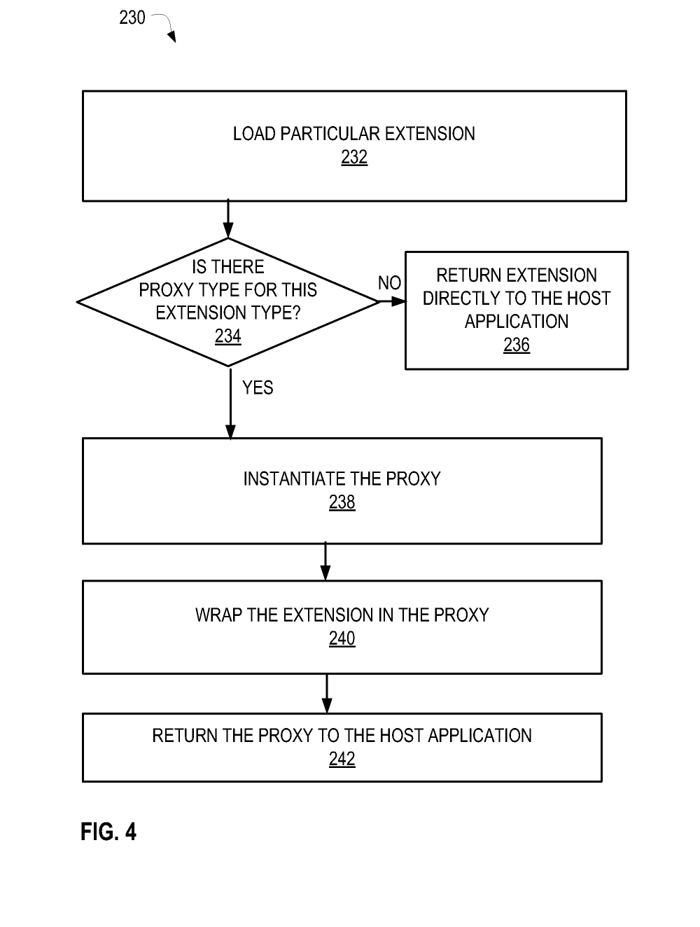

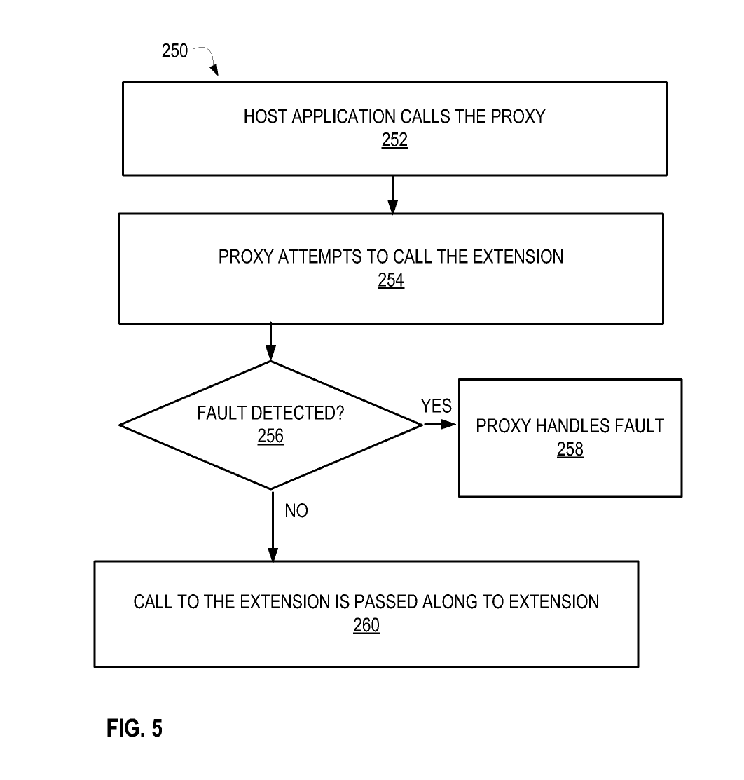

Language syntax 172 of extension manager framework 170 also allows extensions to have a declaration of proxy behavior 178. A proxy can provide a substitute behavior that should be used to wrap each instance of a particular extension in a “pass through manner” such that if a call in the extension fails, the proxy gets a first opportunity to translate the failure into some other result. Similarly, the proxy has the choice not to pass a call through to the inner extension instance. In other words, when a proxy is specified, the proxy is called instead of the extension directly, and then the proxy calls the extension. However, if the proxy intercepts an error, such as when a faulty instance of the extension is encountered, then the proxy may choose to handle the error in some way and bypass calling the extension. The use of proxy behaviors is described in further detail in FIGS. 4 and 5.

Another declaration that language syntax 172 can support is a declaration of instancing rules 180 specifying when a single or more than one extension of a particular type should be loaded, as well default behaviors that define which extension type to choose when there are more than one. For example, when an instance of a specific extension cannot be loaded, a default behavior that was declared for the specific extension can be retrieved, and that default behavior executed for the specific extension.

A singleton behavior declaration 182 can also be used to specify that there should only be one singleton extension per a certain extension type per extension context or instance of an extension manager. The singleton behavior declaration 182 specifies what should be done if more than one extension satisfies the criteria. In one implementation, an extension can declare that it is the “default” singleton, which means that the extension should only be used if no other extension matches the criteria. When there are multiple matches to the criteria, then the extension compatibilities of matching extensions are compared, and the most precise match wins (e.g. that extension will be used over the others).

Other declarations and/or features can also be provided by language syntax 172 of extension manager framework 170 that are not specifically discussed here. For example, a description declaration could be provided to allow descriptions to be provided for an extension. A feature could be provided in language syntax 172 or elsewhere to enable references to be made back to extension manager, such as when a cooperative extension needs to gather other extension information from extension manager. Furthermore, in some implementations, some, additional, and/or other features may be provided in language syntax 172 than those shown in FIG. 2.

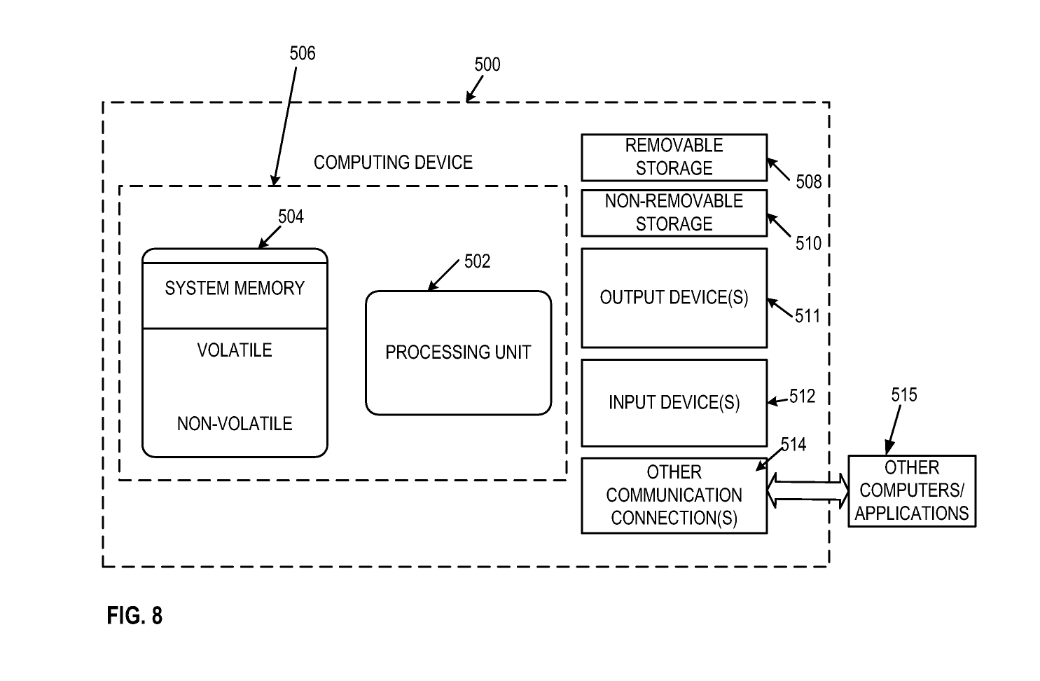

Turning now to FIGS. 3-7, the stages for implementing one or more implementations of extension manager system 100 are described in further detail. In some implementations, the processes of FIG. 3-7 are at least partially implemented in the operating logic of computing device 500 (of FIG. 8).

FIG. 3 is a process flow diagram 200 that illustrates one implementation of the stages involved in loading extensions into a host application based upon extension declarations. An extension loading process is initiated for a host application (stage 202), such as when the host application launches or at a later time. Zero or more operative extensions are loaded into the host application (stage 204). In other words, there may not always be an operative extension to load. The declarations of compatibility that are assigned to one or more cooperative extensions are analyzed or otherwise accessed (stage 206). If a particular cooperative extension is compatible with the operative extensions being loaded/already loaded (decision point 208), then the cooperative extension is also loaded into the host application (stage 210). In the case where zero of the operative extensions are loaded, only the cooperative extensions that declare utter agnosticism to the operative extensions will be loaded (i.e. those cooperative extensions that declare they have no restrictions whatsoever).

If, however, the cooperative extension is not declared to be compatible with the operative extensions (decision point 208), then the cooperative extension is not loaded into the host application due to the incompatibility (stage 212). In one implementation, the cooperative extension can be determined to be incompatible because none of the operative extensions loaded are in a list of compatible extensions. In another implementation, the cooperative extension can be determined to be incompatible because a specific operative extension that is loaded is listed as having a specific incompatibility. Other ways for specifying and/or determining compatibility or incompatibility between cooperative extensions and operative extensions can also be used.

FIG. 4 is a process flow diagram 230 that illustrates one implementation of the stages involved in loading proxy behaviors. As described in FIG. 2, a proxy can provide a substitute behavior that should be used to wrap each instance of a particular extension in a “pass through manner” such that if a call in the extension fails, the proxy gets a first opportunity to translate the failure into some other result. Proxies can be declaratively specified for an extension type. At an appropriate time, a particular extension is loaded (stage 232), such as upon host application startup or at another time. If a proxy type has not been defined for the extension type of this particular extension (decision point 234), then the extension is returned directly to the host application (stage 236). If a proxy type has been defined for the extension type of this particular extension (decision point 234), then the proxy is instantiated (stage 238). The extension is then wrapped in the proxy (stage 240), and the proxy is returned to the host application (stage 242).

Turning now to FIG. 5, a process flow diagram 250 is shown for one implementation that illustrates the stages involved in using proxy behaviors at runtime, such as after a given proxy was loaded according to the process described in FIG. 4. A host application calls the proxy at runtime (stage 252). The proxy then attempts to call the extension that the proxy has been declared for (stage 254). If a fault is detected when initiating a call to the extension (decision point 256), then the proxy handles the fault (stage 258), which can include bypassing the call to the extension altogether. If a fault is not detected when initiating a call to the extension (decision point 256), then the call to the extension is passed along as normal (stage 260). In a sense, the proxy serves as a broker or middle-man between the host application and the extension and forwards calls that do not appear to have faults, and otherwise handles calls that have faults. A proxy can also serve other purposes than those specifically described herein, such as to control various types of behavior that should happen when certain events occur. As one non-limiting example, a proxy could be used to manage the different types of extensions that should be called depending on the type of fault or based upon other operating environment circumstances.

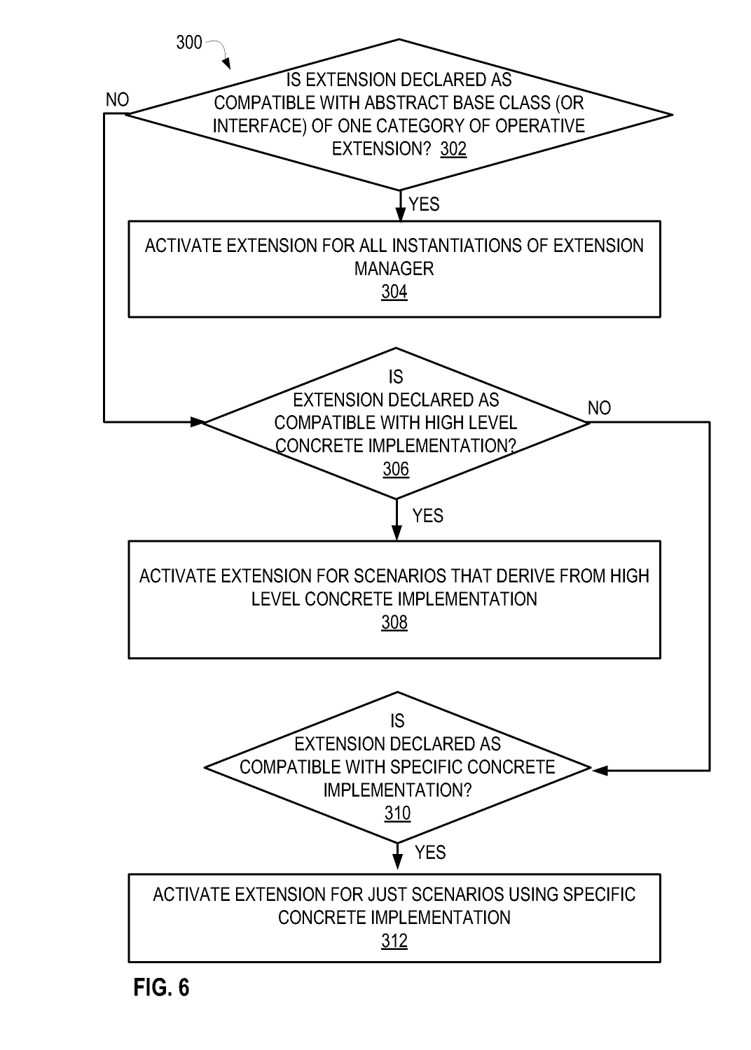

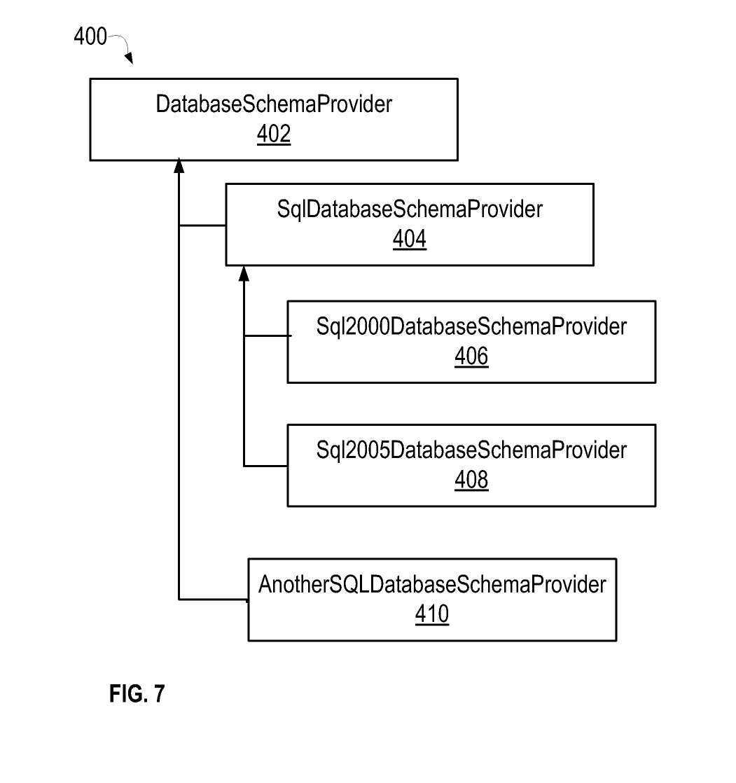

FIG. 6 is a process flow diagram 300 that illustrates one implementation of the stages involved in binding an extension to different levels in an implementation hierarchy based upon declarations of compatibility. If a particular extension being loaded is declared as being compatible with an abstract base class (or interface) of one operative extension type (decision point 302), then the extension is activated for all instantiations of the extension manager that contain operative extensions for that operative extension type (stage 304). If the particular extension is not declared as compatible with an abstract base class (or interface) (decision point 302), then the system determines if the extension is declared as compatible with a high level concrete implementation (decision point 306). If so, then the extension is activated for scenarios that derive from the high level concrete implementation (stage 308). If the extension is not declared as compatible with a high level concrete implementation (decision point 306), then the system determines if the extension is declared as compatible with a specific concrete implementation (decision point 310). If so, then the extension is activated for just scenarios that are using the specific concrete implementation (stage 312). An example that references FIG. 7 will now be used to further illustrate these concepts more clearly.

FIG. 7 is a diagrammatic view of an exemplary derivation hierarchy 400 to which declarations of compatibility could be bound. Suppose the end user has registered SQL Server 2000, SQL Server 2005 and MyDatabasePlatform extensions for a database oriented application. This means that their application's installation (i.e. their host application) will support interaction with these three database platforms. The diagram in FIG. 7 shows how this hierarchy could be laid-out in a derivation hierarchy for the extension in question.

In this example, Sql2000DatabaseSchemaProvider 406, Sql2005DatabaseSchemaProvider 408 and AnotherSqlDatabaseSchemaProvider 410 represent concrete implementations of extensions which are identified by the base extension type, DatabaseSchemaProvider 402. Additionally, SqlDatabaseSchemaProvider 404 is an abstract base class of the two SQL Server implementations in this example. SqlDatabaseSchemaProvider 404 can be used both for shared functionality as well as for an identification of the two derived implementations, for extensions that wish to declare their compatibility with both.

Continuing the example from FIG. 6, any extension in the application that declares its compatibility with DatabaseSchemaProvider 402 will be activated for all instantiations of the extension manager 108, regardless of loaded operative extensions (stage 304 of FIG. 6). If an extension declares its compatibility with SqlDatabaseSchemaProvider 404, then that extension will only be activated for cases that use the concrete implementations Sql2000DatabaseSchemaProvider 406 and Sql2005DabaseSchemaProvider 408 (stage 308 of FIG. 6). Finally, if an extension declares its compatibility with one of the three concrete implementations Sql2000DatabaseSchemaProvider 406, Sql2005DatabaseSchemaProvider 408 or AnotherSqlDatabaseSchemaProvider 410, then it will only be activated for the specific case (stage 312 of FIG. 6). In other words, the higher the level that a particular extension is declared to be compatible with (to bind to), then the more scenarios that extension will be loaded into a particular host application, but possibly with less certainty as to how the loaded extensions will interact with one another.

As shown in FIG. 8, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 8 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 8 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here. In one implementation, computing device 500 includes extension manager system 100.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A system for managing extensions comprising:
an extension manager, the extension manager being operable to interact with a plurality of extensions, a first set of the extensions belonging to a first category of extensions and a second set of the extensions belonging to a second category of extensions, wherein the second set of extensions contain one or more declarations of compatibility with one or more extensions in the first set of extensions, the extension manager being further operable to load zero or more extensions from the first set of extensions into a host application, and the extension manager being further operable to load zero or more extensions from the second set of extensions into the host application based upon an analysis of the one or more declarations of compatibility.

2. The system of claim 1, wherein the extension manager is operable to be created for each instance of the host application.

3. The system of claim 1, wherein multiple instances of the extension manager is operable to be created for the host application.

4. The system of claim 1, wherein the first category of extensions includes operative extensions.

5. The system of claim 1, wherein the second category of extensions includes cooperative extensions.

6. The system of claim 1, wherein the extension manager is operable to detect that an instance of a specific extension of the plurality of extensions could not be loaded, to retrieve a default behavior that is declared for the specific extension, and to execute the default behavior for the specific extension.

7. The system of claim 1, wherein the extension manager is operable to detect that a singleton behavior has been specified for a specific type of extension of the plurality of extensions, and to then ensure that only one of the specific type of extension is loaded at a given time.

8. The system of claim 1, wherein the extension manager is further operable to receive a context request from a specific extension of the plurality of extensions, and to return information to the specific extension about other extensions that share a current context with the specific extension.

9. The system of claim 1, wherein the extension manager is operable to use a proxy that was specified using a declaration, the proxy being operable to manage communications between the host application and a specific extension so that faulty behavior can be detected and handled separately from the specific extension.

10. A method for loading extensions into a host application based upon extension declarations comprising the steps of:
initiating an extension loading process for a host application;
loading one or more operative extensions into the host application;
analyzing at least one declaration of compatibility assigned to at least one cooperative extension; and
when the analyzing step reveals that the at least one cooperative extension is compatible with the one or more operative extensions that are being loaded, then loading the at least one cooperative extension into the host application.

11. The method of claim 10, wherein the at least one declaration of compatibility is defined at design time.

12. The method of claim 10, wherein the at least one declaration of compatibility is contained in one or more executable versions of the at least one cooperative extension.

13. The method of claim 10, wherein the at least one declaration of compatibility is contained in one or more extension declaration files associated with the at least one cooperative extension.

14. The method of claim 10, further comprising:
when a specific cooperative extension of the one or more cooperative extensions cannot be loaded, then accessing a default behavior associated with the specific cooperative extension, and then executing the default behavior.

15. An extension manager framework comprising:
a framework having a language syntax for describing the operation of a plurality of extensions, the language syntax being operable to enable a cooperative extension to declare compatibility with one or more operative extensions, so that the cooperative extension is only loaded into a host application in situations where the cooperative extension has been pre-defined as being compatible.

16. The extension manager framework of claim 15, wherein the language syntax is further operable to allow incompatibility with at least one of the one or more operative extensions to be declared.

17. The extension manager framework of claim 15, wherein the language syntax is further operable to allow SKU binding restrictions to be specified for one or more of the extensions.

18. The extension manager framework of claim 15, wherein the language syntax is further operable to allow a proxy to be specified for handling faulty instances of the extensions that are discovered.

19. The extension manager framework of claim 15, wherein the language syntax is further operable to allow instancing rules to be specified for how many instances of a given extension should be allowed to be created.

20. The extension manager framework of claim 15, wherein the language syntax is further operable to allow a single instance of one type of cooperative extension to be declared for a particular type of extension.
